(19) United States
(12) Patent Application Publication
(10) Pub. No.: US 2007/0068539 A1
(43) Pub. Date: Mar. 29, 2007

(54) Internet based health management system for identifying and minimizing risk factors contributing to metabolic syndrome

(75) Inventors: Christopher Hall, San Francisco, CA (US); Vance Whitson Lanier JR., San Francisco, CA (US); David Shewmake, San Francisco, CA (US); Frank Ruderman, San Rafael, CA (US); Matthew Banet, Del Mar, CA (US); Randon Schultz, Venice, CA (US); Marshal Dhillon, San Diego, CA (US); Adam Fleming, San Diego, CA (US); Henk Visser, San Diego, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Berkeley HeartLab, Inc.

(21) Appl. No.: 11/522,650

(22) Filed: Sep. 18, 2006

Related U.S. Application Data
(60) Provisional application No. 60/721,825, filed on Sep. 29, 2005.

(51) Int. Cl. G06F 19/00

(52) U.S. Cl. 128/898; 702/19

(57) ABSTRACT

The invention provides a system that determines if a patient has Metabolic Syndrome, and in response provides a disease-management program that helps reduce medical risks associated with this malady. The system features a device configured to collect glucose information and blood pressure information, and then transmit this information to a central computer system. The system also includes a database configured to receive triglyceride information and cholesterol information from an external blood test, and a central computer system featuring: 1) a communication interface configured to communicate with the device to receive glucose and blood pressure information and with the database to receive triglyceride and cholesterol information; 2) a user interface configured to accept patient information; and 3) a processor configured to operate an algorithm that processes the glucose, blood pressure, triglyceride, cholesterol, and patient information to determine if the patient has Metabolic Syndrome.

### CROSS REFERENCES TO RELATED APPLICATION

This application claims the benefit of priority of U.S. patent application Ser. No. 60/721,825 filed Sep. 29, 2005 and is hereby incorporated by reference.

### BACKGROUND

1. Field of the Invention

The present invention relates to a patient-monitoring system that processes information from a patient, monitoring device, and one or more blood tests to help diagnose Metabolic Syndrome and in response provide a treatment plan.

2. Description of the Related Art

According to the findings from the Third National Health and Nutrition Examination Survey, 47 million domestic adults have Metabolic Syndrome, also known as Syndrome X. Metabolic Syndrome is characterized by a group of related metabolic risk factors that include: 1) atherogenic dyslipidemia, or blood fat disorders (e.g. high triglyceride and low HDL cholesterol levels) that foster plaque buildup in arterial walls; 2) central obesity or excess fat tissue in or around the abdomen; 3) high systolic and diastolic blood pressure; and 4) insulin resistance or glucose intolerance. The underlying causes of Metabolic Syndrome are typically related to obesity, physical inactivity, and genetic factors.

Metabolic Syndrome is typically diagnosed using proposed criterions suggested by the Adult Treatment Panel III (ATP III). Specifically, the ATP III uses the identification of three or more of the following criteria to diagnose Metabolic Syndrome: 1) central obesity as measured by waist circumference greater than 40 inches for men and 35 inches for women; 2) fasting blood triglycerides greater than or equal to 150 mg/dL; 3) HDL cholesterol less than 40 mg/dL in men, and less than 50 mg/dL for women; 4) blood pressure greater than or equal to 130/85 mmHg; and 5) fasting glucose greater than or equal to 110 mg/dL.

Patients with Metabolic Syndrome inherently have an increased risk of type-II diabetes, along with cardiovascular disease (CVD), coronary heart disease, other diseases (e.g., stroke and peripheral vascular disease) related to plaque buildup in a patient's arterial walls.

### SUMMARY OF THE INVENTION

In one aspect, the invention provides an Internet-based system that determines if a patient has Metabolic Syndrome, and in response provides a customized treatment plan that helps reduce risk and complications associated with this malady. The system features a device configured to collect glucose and blood pressure information, and then transmit this information to a central computer system (e.g., an Internet-based system). The system also includes a database configured to receive triglyceride, cholesterol, and other blood test information from an external blood test. All information is ported to the Internet-based system, which features: 1) a communication interface configured to communicate with the device to receive glucose and blood pressure information and with the database to receive triglyceride and cholesterol information; 2) a user interface configured to accept patient-entered information (e.g., waist circumference); and 3) a processor configured to operate an algorithm that processes the glucose, blood pressure, triglyceride, cholesterol, and patient information to determine if the patient has Metabolic Syndrome.

In embodiments, the device includes a serial interface (e.g., an RS232-based serial port, USB serial port, or wireless interface) configured to collect glucose information from an external glucometer. A blood pressure-monitoring device can be integrated within the device (as described in detail below), or alternatively the same serial interface can collect blood pressure information from an external blood pressure-monitoring device (e.g., a conventional blood pressure cuff featuring a serial interface). If the serial interface is wireless, it can operate protocols such as Bluetooth™, 802.11, 802.15.4, and part-15.

The serial interface on the device can send information to the Internet-based system. In this case, the Internet-based system can be configured to download a software program onto a patient's computer. The software program then collects information through the device's serial interface and sends this to the Internet-based system for further analysis and display.

In other embodiments, the blood test features a test for measuring HDL and/or LDL cholesterol. The test, for example, can be a blood test that fractionalizes HDL and LDL cholesterol to generate sub-classes of these compounds as described in more detail below. In a particular embodiment, the blood test is based on gradient gel electrophoresis (GGE), and is taken alone or combined with other blood tests. Such tests are described in U.S. Pat. No. 5,925,229, entitled “Low density lipoprotein fraction assay for cardiac disease risk”, the contents of which are incorporated herein by reference. Typically the database and Internet-based system communicate with each over through the Internet to simplify the transmission of information from one system to the other.

The user interface is typically an Internet-accessible website that includes multiple web pages and fields designed to accept patient information. For example, a particular field can accept information that describes a patient's waist circumference, along with other information that is not available directly through the device or the blood test (e.g., diet, medical records). In a particular embodiment, an algorithm running on the Internet-based system processes waist circumference along with the glucose, blood pressure, triglyceride, and cholesterol information to determine if the patient has Metabolic Syndrome. To make this determination, the algorithm can process this information in the following way:
fasting glucose≧110 mg/dL
blood pressure>130/85 mmHg
fasting triglycerides>150 mg/dL
HDL cholesterol<40 mg/dL (men); <50 mg/dL (women)
waist circumference>40 inches (men); >35 inches (men)
   Typically three or more positive results from this list typically indicates a patient has Metabolic Syndrome.

In still other embodiments, the Internet-based system further comprises a messaging interface configured to send messages describing Metabolic Syndrome and corresponding diet and treatment plans to the patient's email address, wireless device, or monitoring device. The message is typically a text message, SMS message, HTML-based message, or other form of message that propagates over an http, https, or wireless protocol. The messages can include a variety of content, including diet and exercise recommendations, recipes, program goals, progress toward goals, articles, educational content, links to web pages, or related content.

In other embodiments, the messaging system is additionally configured to receive messages from the patient. For example, the messaging system can send a message that includes a text field wherein the patient can enter a response. In this case, the Internet-based system typically includes a software component that parses the response entered in the text field once the message is received.

The user interface associated with the Internet-based system typically features a website with one or more web pages that display information related to Metabolic Syndrome, taken alone or combined with other information. In embodiments, the website includes a first web interface that displays information for a single patient, and a second web interface that displays information for a group of patients. For example, a medical professional (e.g. a physician, nurse, nurse practitioner, dietician, or clinical educator) associated with a group of patients could use the second web interface to analyze the patient's Metabolic Syndrome diagnosis, and in response recommend a diet and exercise program. Both web interfaces typically include multiple web pages that, in turn, feature both static and dynamic content, described in detail below.

In addition to measuring systolic, diastolic, and pulse blood pressure, the device used in the system can measure: 1) heart rate; 2) pulse oximetry; and 3) cardiac ‘waveforms’ that can be further processed to determine arrhythmias, blood pressure load, cardiac stroke volume, and other cardiac properties. These properties can be measured daily as a one-time measurement, or quasi-continuously (e.g., every 30 seconds) during exercise. Preferably the monitoring device measures blood pressure without using a cuff, as described in detail below. This means patients can quickly and easily monitor blood pressure and other vital signs with minimal discomfort. With this device patients can easily measure their vital signs throughout the day (e.g., while at work) to generate a complete set of information, rather than just a single, isolated measurement.

In other embodiments, the monitoring device can collect weight and percent body fat from a bathroom scale (using, e.g., a wired or wireless link), and exercise-related properties, such as steps (using an internal pedometer circuit), calories burned (using sensor inputs and associated algorithms), and exercise time (using a simple clock).

‘Blood test information’, as used herein, means information collected from one or more blood tests, such as a GGE test, lipid panel, or any conventional blood test. Blood test information can include concentration, density, amounts, or any other information describing blood-borne compounds, including but not limited to total cholesterol, LDL cholesterol (and subclass distribution), HDL cholesterol (and subclass distribution), triglycerides, Apo B particle, Apo B ultra particle, lipoprotein, Apo E genotype, fibrinogen, folate, HbA_{1c}, C-reactive protein, homocysteine, glucose, insulin, chlamydia, and other compounds. ‘Vital sign information’, as used herein, means information collected from patient using a medical device that monitors the patient. This information includes but is not limited to heart rate (measured at rest and during exercise), blood pressure (systolic, diastolic, and pulse pressure), blood pressure waveform, pulse oximetry, optical plethysmograph, electrical impedance plethysmograph, stroke volume, ECG and EKG, temperature, weight, percent body fat, and other properties. ‘Exercise information’, as used herein, means information that characterizes a patient's exercise habits, including but not limited to steps, miles run or biked, duration of any type of exercise, degree of exertion during exercise, calories burned during exercise, and heart rate and other cardiovascular information measured during exercise. ‘Personal information’, as used herein, means information such as age, gender, medical history, ethnicity, current medications, and other information that can be used alone or in combination with the above-mentioned properties to, among other things, develop metabolic and cardiovascular risk profiles to diagnose and manage a patient.

The invention has many advantages, particularly because it provides an Internet-based system that processes blood test, vital sign, and personal information to determine if a patient has Metabolic Syndrome. In response, the system can generate personalized diet and treatment plans for a patient. Ultimately the Internet-based system, monitoring device, and messaging platform combine to form an interconnected, easy-to-use tool that can engage the patient in a disease-management program, encourage follow-on medical appointments, and build patient compliance. These factors, in turn, can help the patient lower their risk for medical conditions related to Metabolic Syndrome, such as CVD.

These and other advantages of the invention will be apparent from the following detailed description and from the claims.

### BRIEF DESCRIPTION OF THE DRAWINGS

FIG. 1 is a schematic drawing of an Internet-based health management system that generates a patient-specific health plan by processing, e.g., a Metabolic Syndrome checklist, blood test information, general patient information, and vital sign information from a monitoring device;

FIG. 2 shows the Metabolic Syndrome checklist used by the health management system of FIG. 1;

FIG. 3 shows a report generated from the health management system of FIG. 1 that displays results from a patient's blood test; and,

FIG. 4 is a semi-schematic view of the monitoring device from FIG. 1 that connects through a USB port to a personal computer to upload vital signs to the health management system of FIG. 1.

### DETAILED DESCRIPTION OF THE INVENTION

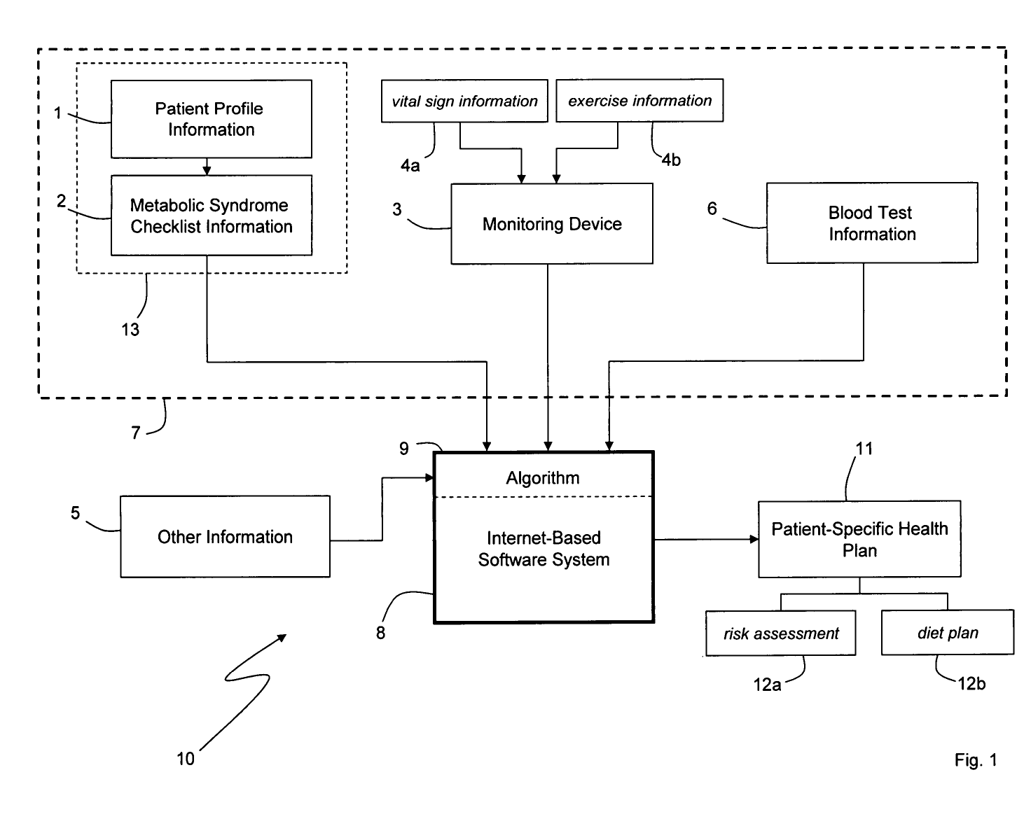

FIG. 1 shows a schematic view of a health management system 10 according to the invention that determines if a patient has Metabolic Syndrome, and if so provides an associated treatment plan. The system 10 collects and provides a series of inputs 7 that include patient profile information 1, Metabolic Syndrome checklist information 2, blood test information 6, and vital sign 4a and exercise 4b information from a monitoring device 3. An algorithm 9 within an Internet-based software system 8 receives the inputs 7, along with other information 5 such as the patient's medications and medical history, and processes them to generate a patient-specific health plan 11 that features a risk assessment 12a that analyzes the patient's risk for conditions related to Metabolic Syndrome, and a diet plan 12b engineered to ameliorate these conditions.

The blood test 6, for example, may be a GGE-based blood test that detects blood-borne properties such as total cholesterol, LDL cholesterol, and HDL cholesterol, and sub-classes of LDL and HDL cholesterol. GGE typically differentiates up to seven subclasses of LDL cholesterol (classified as LDL I, Ia, IIb, IIIa, IIIb, IVa, and IVb), and up to five subclasses of HDL (classified as HDL 2b, 2a, 3a, 3b, 3c). Other complementary blood tests can detect blood test information 6 such as triglycerides, Apo B-Particle, Apo B ultra particle, lipoprotein, fibrinogen, folate, HbA_{1c}, C-reactive protein, homocysteine, glucose, insulin, and chlamydia.

The monitoring device 3 typically measures information from the patient such as blood pressure, pulse oximetry, heart rate, glucose levels, calories burned and steps traveled. Such a monitoring device is described in Provisional Application Ser. No. 60/721,665 which was filed on Sep. 29, 2005 and is incorporated herein by reference. Such a monitoring device is described in U.S. Ser. No. ______, filed on even date herewith, and entitled MONITORING DEVICE FOR MEASURING CALORIE EXPENDITURE, the contents of which are incorporated herein by reference. This patent application describes a monitoring device that is typically worn on the patient's belt and features: i) an integrated, optical ‘pad sensor’ that cufflessly measures blood pressure, pulse oximetry, and heart rate from a patient's finger as described in more detail below; and ii) an integrated pedometer circuit that measures steps and, using one or more algorithms, calories burned. To receive information from external devices, such as a glucometer, the monitoring device also includes: i) a serial connector that connects and downloads information from the external device; and ii) a short-range wireless transceiver that receives information such as body weight and percentage of body fat from an external scale.

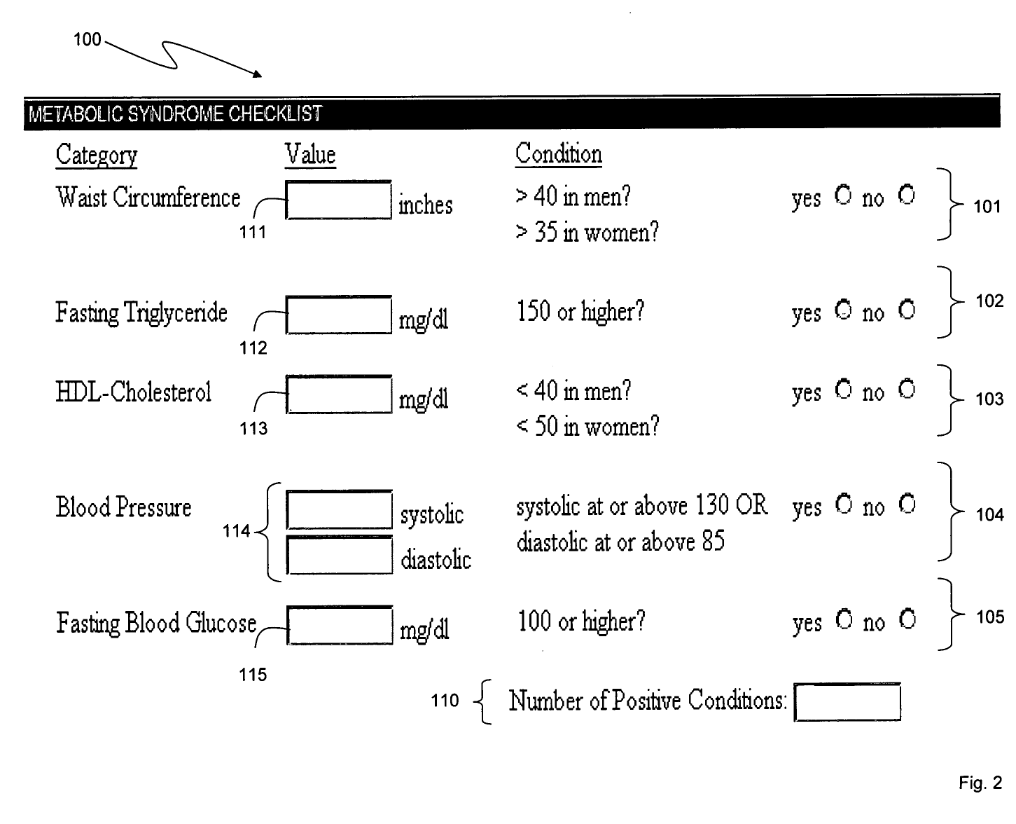

FIG. 2 shows a Metabolic Syndrome checklist 100 used in the system described above. The checklist 100 is typically rendered on a web page associated with the Internet-based software system. Each category in the checklist 100 identifies factors required to determine Metabolic Syndrome. These factors include: waist circumference 111, fasting triglyceride levels 112, HDL cholesterol levels 113, systolic and diastolic blood pressure 114, and fasting blood glucose levels 115. The specific metrics associated with these factors and used to determine Metabolic Syndrome are:
fasting glucose≧110 mg/dL
blood pressure>130/85 mmHg
fasting triglycerides>150 mg/dL
HDL cholesterol<40 mg/dL (men); <50 mg/dL (women)
waist circumference>40 inches (men); >35 inches (men)
   During operation, a patient record values into the checklist 100 for each factor, which in response determines either a positive or negative condition 101, 102, 103, 104, and 105. An algorithm adds the positive conditions to generate a total number of positive conditions 110, with three or more positive conditions required to confirm a diagnosis of Metabolic Syndrome.

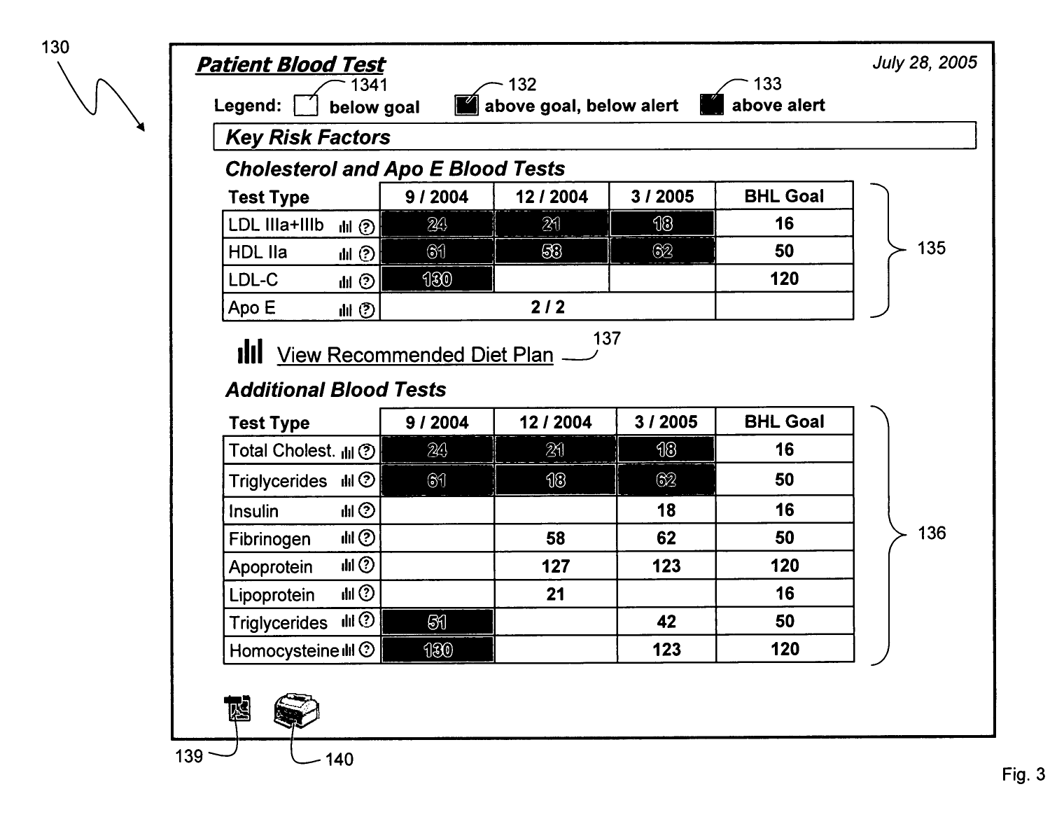

The Internet-based system shown in FIG. 1 can render web pages associated with a disease-management program. For example, as shown in FIG. 3, the system can generate a web-based report 130 that features a first region 135 describing LDL cholesterol sub-classes and Apo E, and a second region 136 that describes blood test information taken from a series of conventional blood tests. The report 130 also includes a link 137 that, when clicked, renders a personalized diet plan based on the patient's Metabolic Syndrome checklist values and personal information. The web page is typically made available to both the patient and a medical professional through separate interfaces. Parameters in the first 135 and second 136 regions are compared to values recommended by the medical professional associated with the Internet-based system. Typically, these parameters are color-coded according to how they compare to the recommended values, and are grouped into the following categories: ‘below goal’ 131; ‘above goal, below alert’ 132; and ‘above alert’ 133. ‘below goal’ 131 means a parameter has not met the goal established by the medical professional. Parameters that meet a goal, but fall under the status of an ‘alert’, are categorized as ‘above goal, below alert’ 132. A parameter that increases beyond that set by the medical professional falls into ‘above alert’ status 133. The web page also includes a link 139 that renders a PDF document describing the report's results, and a link 140 for printing the report.

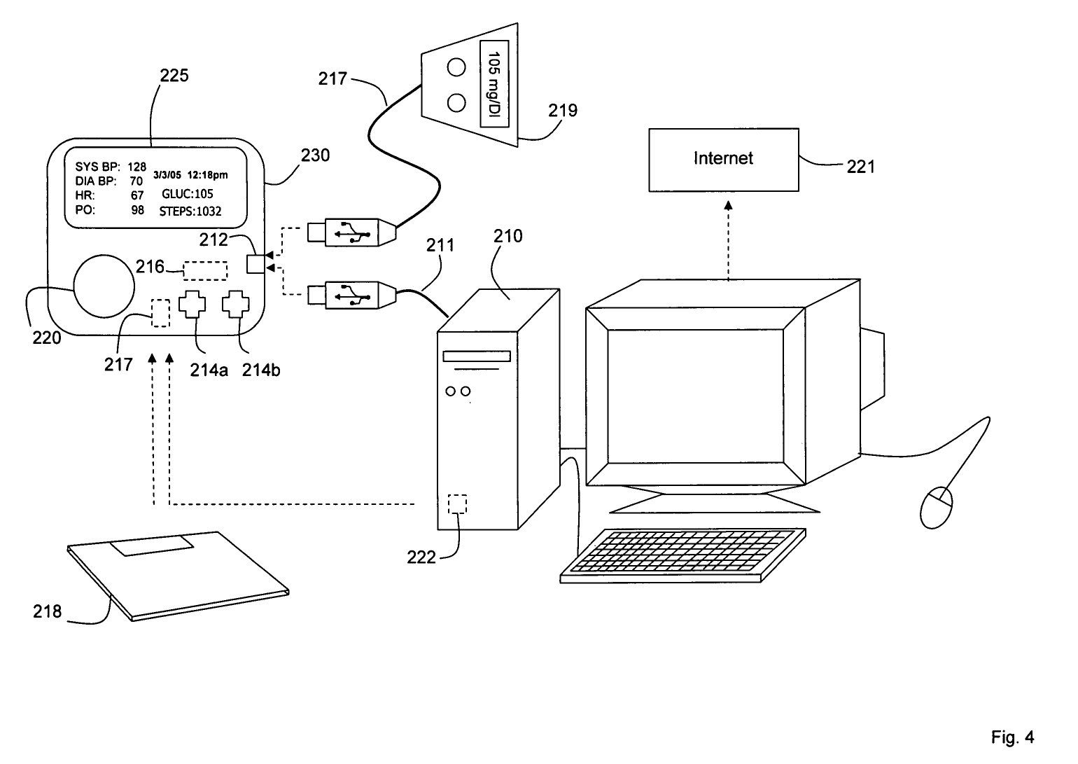

FIG. 4 shows the monitoring device 230 described with reference to FIG. 1 that provides vital sign information to the Internet-based system for use in the Metabolic Syndrome checklist. The device 230 includes a USB port 212 that connects through a first cable 217 to an external glucometer to collect a patient's glucose levels. The USB port 212 can also connect through a second cable 211 to a personal computer 210 that connects to the Internet 221 to communicate with the Internet-based software system shown in FIG. 1. The monitoring device 230, which during use is typically attached to the patient's belt, features: i) an integrated, optical ‘pad sensor’ 220 that cufflessly measures blood pressure, pulse oximetry, and heart rate from a patient's finger as described in more detail below; and ii) an integrated pedometer circuit 216 that measures steps and, using an algorithm, calories burned. The monitoring device 230 also includes a short-range wireless transceiver 217 that receives information such as body weight and percentage of body fat from an external scale 218. The wireless transceiver 217 can also communicate wirelessly with a matched transceiver 222 within the personal computer 210 to download information.

The patient views information stored in the monitor 230 using an LCD 225, and can interact with the monitor 230 (e.g., reset or reprogram it) using a series of buttons 214a, 214b.

Methods used by the monitoring device for measuring vital signs and particularly cuffless blood pressure are described in the following co-pending patent applications, the entire contents of which are incorporated by reference: 1) CUFFLESS BLOOD-PRESSURE MONITOR AND ACCOMPANYING WIRELESS, INTERNET-BASED SYSTEM (U.S. Ser. No. 10/709,015; filed Apr. 7, 2004); 2) CUFFLESS SYSTEM FOR MEASURING BLOOD PRESSURE (U.S. Ser. No. 10/709,014; filed Apr. 7, 2004); 3) CUFFLESS BLOOD PRESSURE MONITOR AND ACCOMPANYING WEB SERVICES INTERFACE (U.S. Ser. No. 10/810,237; filed Mar. 26, 2004); 4) VITAL SIGN MONITOR FOR ATHLETIC APPLICATIONS (U.S. Ser. No.; filed Sep. 13, 2004); 5) BLOOD PRESSURE MONITORING MONITOR FEATURING A CALIBRATION-BASED ANALYSIS (U.S. Ser. No. 10/967,610; filed Oct. 18, 2004); 6) PERSONAL COMPUTER-BASED VITAL SIGN MONITOR (U.S. Ser. No. 10/906,342; filed Feb. 15, 2005); 7) PATCH SENSOR FOR MEASURING BLOOD PRESSURE WITHOUT A CUFF (U.S. Ser. No. 10/906,315; filed Feb. 14, 2005); and 8) SMALL-SCALE, VITAL SIGNS MONITORING MONITOR, SYSTEM AND METHOD (U.S. Ser. No. 10/907,440; filed Mar. 31, 2005).

Other embodiments are also within the scope of the invention. In particular, the algorithm can recommend diets other than those described in the above-mentioned examples. These diets can be structured in a number of different ways, such as number of calories, ‘points’ corresponding to certain food groups, number of carbohydrates, types of foods, etc.

In other embodiments, the web pages used to display information described above can take many different forms, as can the manner in which the data are displayed. Web pages are typically written in a computer language such as ‘HTML’ (hypertext mark-up language), and may also contain computer code written in languages such as Java and Java script for performing certain functions (e.g., sorting of names). The web pages are also associated with database software (provided by companies such as Oracle and Microsoft) that is used to store and access data. Equivalent versions of these computer languages and software can also be used. In general, the graphical content and functionality of the web pages may vary substantially from what is shown in the above-described figures. In addition, web pages may also be formatted using standard wireless access protocols (WAP) so that they can be accessed using wireless devices such as cellular telephones, personal digital assistants, and related devices.

Still other embodiments are within the scope of the following claims.

I claim as my invention:

1. A system for diagnosing Metabolic Syndrome, comprising:
a device comprising: 1) a data-collection component configured to collect glucose information and blood pressure information; and 2) a data-transmission component configured to transmit the glucose information and blood pressure information to a central computer system;
a database configured to receive triglyceride information and cholesterol information from a blood test; and
a central computer system comprising: 1) a communication interface configured to communicate with the device to receive glucose and blood pressure information and with the database to receive triglyceride and cholesterol information; 2) a user interface configured to accept patient information; and 3) a processor configured to operate an algorithm that processes the glucose, blood pressure, triglyceride, cholesterol, and patient information to diagnose Metabolic Syndrome.

2. The system of claim 1, wherein the data-collection component further comprises a serial interface configured to collect glucose information from an external glucometer.

3. The system of claim 1, wherein the serial interface is a USB serial port.

4. The system of claim 1, wherein the device further comprises a system for measuring blood pressure information.

5. The system of claim 1, wherein the data-collection component further comprises a serial interface configured to collect blood pressure information from an external blood pressure-monitoring device.

6. The system of claim 1, wherein the data-transmission component comprises a serial interface.

7. The system of claim 6, wherein the communication interface comprises a software program configured to collect glucose and blood pressure information from the data-transmission component of the device.

8. The system of claim 7, wherein the central computer system is further configured to download the software program onto a computer.

9. The system of claim 1, wherein the blood test comprises a test for measuring HDL cholesterol, and the database is further configured to receive the HDL cholesterol.

10. The system of claim 1, wherein the database and central computer system are further configured to communicate with each over through the Internet.

11. The system of claim 1, wherein the central computer system further comprises a connection to the Internet.

12. The system of claim 11, wherein the user interface comprises an Internet-accessible website.

13. The system of claim 1, wherein the user interface further comprises a field to accept patient information that describes waist circumference.

14. The system of claim 1, wherein the algorithm processes the glucose, blood pressure, triglyceride, cholesterol, and patient information in the following way to determine if the patient has Metabolic Syndrome:
fasting glucose≧110 mg/dL
blood pressure>130/85 mmHg
fasting triglycerides>150 mg/dL
HDL cholesterol<40 mg/dL (men); <50 mg/dL (women)
waist circumference>40 inches (men); >35 inches (men).

15. The system of claim 1, wherein the central computer system further comprises a messaging interface configured to send a message to the patient after the algorithm processes the glucose, blood pressure, triglyceride, cholesterol, and patient information.

16. The system of claim 1, where the messaging interface is further configured to send an email, text message, or phone call to the patient.

17. A system for diagnosing Metabolic Syndrome, comprising:
a device comprising: 1) a data-collection component configured to collect glucose information and blood pressure information; and 2) a data-transmission component configured to transmit the glucose information and blood pressure information to a central computer system;
a database configured to receive triglyceride information and cholesterol information from a blood test; and
a central computer system comprising: 1) a communication interface configured to communicate with the device to receive glucose and blood pressure information and with the database to receive triglyceride and cholesterol information; 2) a user interface configured to accept patient information; 3) a processor configured to operate an algorithm that processes the glucose, blood pressure, triglyceride, cholesterol, and patient information to determine if a patient has Metabolic Syndrome; and 4) a messaging interface configured to send a message to the patient.

18. A system diagnosing Metabolic Syndrome, comprising:
a device comprising: 1) a data-collection component configured to collect glucose information from an external glucometer; 2) an integrated blood pressure monitor configured to measure blood pressure; and 3) a data-transmission component configured to transmit the glucose information and blood pressure information to a central computer system;
a database configured to receive triglyceride information and cholesterol information from a blood test; and
a central computer system comprising: 1) a communication interface configured to communicate with the device to receive glucose and blood pressure information and with the database to receive triglyceride and cholesterol information; 2) a user interface configured to accept patient information; 3) a processor configured to operate an algorithm that processes the glucose, blood pressure, triglyceride, cholesterol, and patient information to determine if a patient has Metabolic Syndrome; and 4) a messaging interface configured to send a message to the patient.
